(19) United States
(12) Patent Application Publication
(10) Pub. No.: US 2024/0111896 A1
(43) Pub. Date: Apr. 4, 2024

(54) SPLITTING AND RECONSTRUCTING DATA BETWEEN SECURE AND NONSECURE DATABASES

(71) Applicant: International Business Machines Corporation, Armonk, NY (US)

(72) Inventors: Meghan McGrath, Highland, NY (US); Jonathan Fry, Fishkill, NY (US); MICHAEL KANE, Poughkeepsie, NY (US); James Cox, Lagrangeville, NY (US); Ximena Bates-Forero, Schererville, IN (US)

(21) Appl. No.: 17/937,122

(22) Filed: Sep. 30, 2022

(51) Int. Cl. G06F 21/62

(52) U.S. Cl. CPC G06F 21/6254

(57) ABSTRACT

A method, an apparatus, a system, and a computer program product for processing messages. A computer system parses a message to identify key value pairs for confidential information in the message. The computer system creates a redacted message in which values in the key value pairs identified for the confidential information are replaced with plaintext tags. The computer system stores the key value pairs in a secure database. The computer system stores the redacted message in a plaintext database.

### BACKGROUND

### 1. Field

The disclosure relates generally to an improved computer system and more specifically to a method, apparatus, system, and computer program product for processing messages containing confidential information.

### 2. Description of the Related Art

Data privacy is an important issue with the widespread use of the Internet for activities such as sending messages, sharing information, selling and buying items, and performing commercial transactions. Many countries and organizations have rules on data protection and privacy. These laws govern how data is collected, stored, and distributed for individuals.

For example, the General Data Protection Regulation (GDPR) is a European Union (EU) regulation that governs how information is handled for individuals who are referred to as data subjects. GPDR includes provisions and requirements related to the processing of data for data subjects located in the European Economic Area (EEA). These provisions and requirements apply to any organization regardless of the location of the organization.

For example, GDPR specifies how data in email correspondence, webforms, interactive chats, a fillable document, and other types of messages are handled. Unsolicited information received by organizations must be handled properly to avoid fines or other penalties. This regulation has been a model for laws in other countries in the world.

### SUMMARY

According to one illustrative embodiment, a computer implemented method for processing messages is provided. A computer system parses a message to identify key value pairs for confidential information in the message. The computer system creates a redacted message in which values in the key value pairs identified for the confidential information are replaced with plaintext tags. The computer system stores the key value pairs in a secure database. The computer system stores the redacted message in a plaintext database. According to other illustrative embodiments, a computer system and a computer program product for processing messages are provided.

### BRIEF DESCRIPTION OF THE DRAWINGS

FIG. 1 is a block diagram of a computing environment in which illustrative embodiments can be implemented;

FIG. 2 is a block diagram of a message environment in accordance with an illustrative embodiment;

FIG. 3 is a flowchart of a process for splitting data in a message between a secure database and a plaintext database in accordance with an illustrative embodiment;

FIG. 4 is a flowchart of a process a flowchart for accessing messages in accordance with an illustrative embodiment in accordance with an illustrative embodiment;

FIG. 5 is a flowchart of a process for purging data in a secure database in accordance with an illustrative embodiment;

FIG. 6 is a flowchart of a process for updating a user profile in accordance with an illustrative embodiment;

FIG. 7 is a flowchart of a process processing messages in accordance with an illustrative embodiment;

FIG. 8 is a flowchart of a process for accessing messages in accordance with an illustrative embodiment;

FIG. 9 is a flowchart of a process for recreating a message in accordance with an illustrative embodiment;

FIG. 10 is a flowchart of a process for recreating a message in accordance with an illustrative embodiment;

FIG. 11 is a flowchart of a process for storing key value pairs in accordance with an illustrative embodiment;

FIG. 12 is a flowchart of a process for managing user profiles in accordance with an illustrative embodiment;

FIG. 13 is a flowchart of a purging key value pairs in accordance with an illustrative embodiment; and

FIG. 14 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

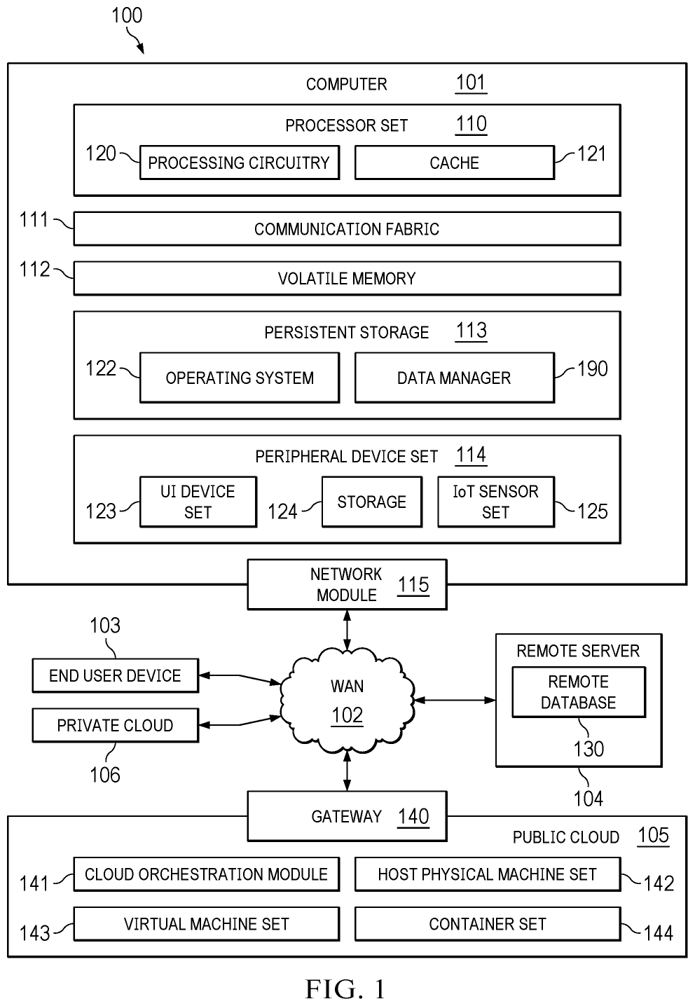

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as data manager 190. In this illustrative example, data manager 190 can handle messages containing confidential information that meets a policy or regulation for handling confidential information. In addition to data manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, different embodiments recognize and take into account that organizations commonly leak protected data to third parties through online “Contact Us” type forms but may not realize that the data leak has occurred. Fines under GDPR and regulations in other countries can be enormous regardless of whether the leakage of information was intentional or not and regardless of whether the leakage was realized or not.

For example, when requesting information through online forms on websites, a user may include information such as credit card numbers, phone numbers, addresses, or other information that should be protected. This information may be included even though the information was not requested from the user. An organization may not realize that the online form filled out by a user contains protected information that should be handled securely.

Thus, the illustrative examples provide a method, apparatus, system, and computer program product for processing messages. In one illustrative example, a computer system parses a message to identify key value pairs for confidential information in the message. The computer system creates a redacted message in which values in the key value pairs identified for the confidential information are replaced with plaintext tags. The computer system stores the key value pairs in a secure database. The computer system stores the redacted message in a plaintext database.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

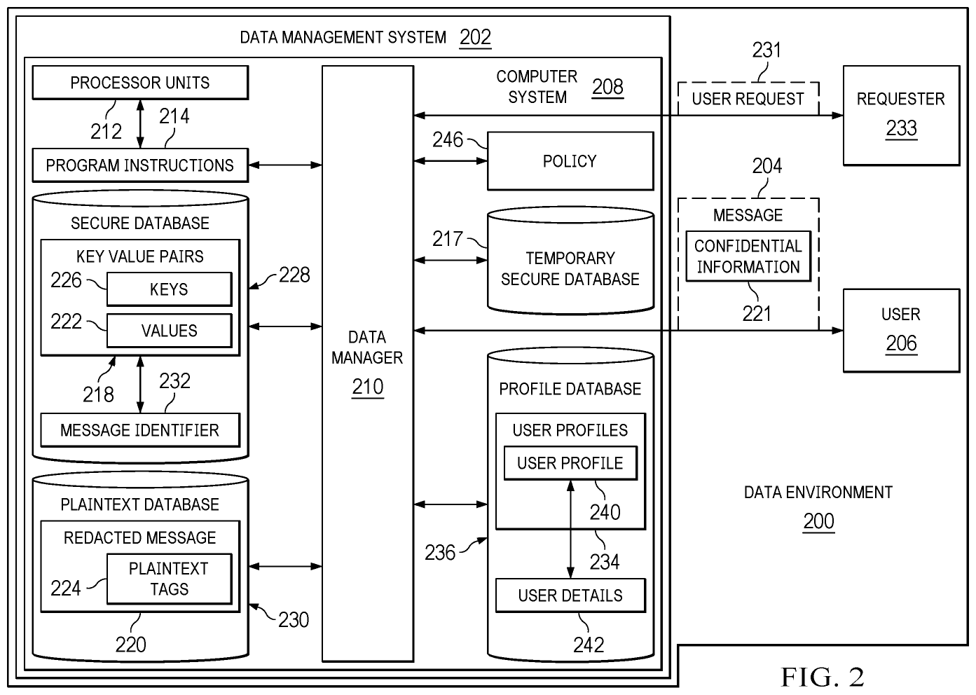

With reference now to FIG. 2, a block diagram of a message environment is depicted in accordance with an illustrative embodiment. In this illustrative example, data environment 200 includes components that can be implemented in hardware such as the hardware shown in computing environment 100 in FIG. 1.

In this illustrative example, data management system 202 in data environment 200 can manage the processing of incoming data received in message 204 from user 206. As depicted, data management system 202 comprises computer system 208 and data manager 210. Data manager 210 is an example of data manager 190 in FIG. 1.

Data manager 210 can be implemented in software, hardware, firmware or a combination thereof. When software is used, the operations performed by data manager 210 can be implemented in program instructions configured to run on hardware, such as a processor unit. When firmware is used, the operations performed by data manager 210 can be implemented in program instructions and data and stored in persistent memory to run on a processor unit. When hardware is employed, the hardware can include circuits that operate to perform the operations in data manager 210.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 208 is a physical hardware system and includes one or more data processing systems. When more than one data processing system is present in computer system 208, those data processing systems are in communication with each other using a communications medium. The communications medium can be a network. The data processing systems can be selected from at least one of a computer, a server computer, a tablet computer, or some other suitable data processing system.

As depicted, computer system 208 includes a number of processor units 212 that are capable of executing program instructions 214 implementing processes in the illustrative examples. As used herein, a processor unit in the number of processor units 212 is a hardware device and is comprised of hardware circuits such as those on an integrated circuit that respond and process instructions and program instructions that operate a computer. When the number of processor units 212 execute program instructions 214 for a process, the number of processor units 212 is one or more processor units that can be on the same computer or on different computers. In other words, the process can be distributed between processor units 212 on the same or different computers in a computer system.

Further, the number of processor units 212 can be of the same type or different type of processor units. For example, the number of processor units 212 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, message 204 can take a number of different forms. For example, message 204 can be an online form, an email message, a chat message, or some other data structure that can be sent by user 206 to data manager 210. In this illustrative example, data in message 204 can be unstructured data. In other words, the data does not need to include any particular format or organization.

In this illustrative example, in response to receiving message 204, data manager 210 stores message 204 in temporary secure database 217. As depicted, temporary secure database 217 is a temporary holding cell for incoming messages to be processed by data manager 210. Temporary secure database 217 can have at least one of a desired level of encryption, access control, or other security measures that meet rules and regulations such as those for General Data Protection Regulation (GDPR). This database enables holding messages temporarily until they are processed.

As depicted, data manager 210 obtains message 204 from temporary secure database 217 and parses message 204 to identify key value pairs 218 for confidential information 221 in the message 204. Data manager 210 creates redacted message 220 using key value pairs 218 identified for message 204. In this illustrative example, values 222 in key value pairs 218 identified for confidential information 221 are replaced with plaintext tags 224 in redacted message 220. In this illustrative example, values 222 are confidential information 221 identified from parsing message 204 to determine key value pairs 218. In this illustrative example, plaintext tags 224 are keys 226 in key value pairs 218.

Further, in this illustrative example, data manager 210 stores redacted message 220 in plaintext database 230. Plaintext database 230 can also have security measures in some illustrative examples.

As depicted, data manager 210 stores key value pairs 218 in secure database 228. In the illustrative example, secure database 228 is a repository having security meeting a policy or regulation. For example, secure database 228 can store data using an encryption algorithm that transforms key value pairs 218 into ciphertext that is incomprehensible without being decrypted. Additionally, secure database 228 can have other security measures such as an access control list (ACL) system that allowing access only to users that are authorized to access key value pairs 218.

In this illustrative example, data manager 210 stores key value pairs 218 with message identifier 232 for message 204 and plaintext tags 224. In this example, plaintext tags 224 can be key 226 in key value pairs 218. Message identifier 232 can be used to locate redacted message 220 in plaintext database 230.

Although redacted message 220 is a redacted version of message 204, redacted message 220 retains the same message identifier in these examples. In this example, plaintext tags 224 are keys 226 while confidential information 221 replaced by plaintext tags 224 are values 222. With this storage of key value pairs 218 and message identifier 232, message 204 can be reconstructed from redacted message 220 that contains plaintext tags 224 in place of values 222 for confidential information 221.

As depicted, data manager 210 can reconstruct message 204 from redacted message 220. In one illustrative example, in response user request 231 from requester 233, data manager 210 verifies requester 233 requesting access to message 204 is authorized to access message 204 in response to user request 231 for message 204. In this example, the authorization can include verifying the identity of requester 233, determining whether requester 233 has privileges to access message 204, and other parameters that may be used to control access to messages in secure database 228 by authorized users.

In this illustrative example, data manager 210 recreates message 204 using redacted message 220 and key value pairs 218. For example, data manager 210 locates redacted message 220 using message identifier 232, and replaces plaintext tags 224 in redacted message 220 with values 222 from key value pairs 218 corresponding to plaintext tags 224. In other words, data manager 210 can replace plaintext tags 224 with values 222 based on keys 226 in which keys 226 are plaintext tags 224 in redacted message 220.

In this illustrative example, data manager 210 can re-create message 204 from redacted message 220 by replacing a number of plaintext tags 224 with a number of the values 222 from key value pairs 218 corresponding to the number of plaintext tags 224. In other words, the replacement of plaintext tags 224 with values 222 may be only for some portion of plaintext tags 224 or can be all of plaintext tags 224.

For example, the number of plaintext tags 224 replaced with the number of values 222 in key value pairs 218 can be selected by at least one of a user input selecting the number of plaintext tags 224, user permissions, a geographic location of the user, or some other criteria. In some examples, requester 233 may only want to see some values in redacted message 220. Further, depending on the access level that requester 233 has only some of plaintext tags 224 may be replaced with values 222 because of the level of access for requester 233.

Additionally, geographic locations may restrict what plaintext tags can be replaced with values 222. Different geographic locations may have different rules or laws governing what values 222 for confidential information 221 in message 204 can be accessed by requester 233.

In another illustrative example, user profiles 234 can be stored in profile database 236 that is security compliant. Profile database 236 may have the same level of security or a different level of security as compared to secure database 228 and temporary secure database 217 depending on the particular rules for managing information and profile database 236.

In this example, data manager 210 updates user profile 240 with number of key value pairs 218 that match user details 242 for user profile 240 stored in profile database 236 that is security compliant. In this illustrative example, user details 242 can be types of information that are stored for a user in user profile 240. For example, user details 242 can be selected from at least one of a Social Security number, credit card number, a mailing address, email address, a phone number, a bank account number, a national ID, a pin number, a date of birth, or other types of information for a user in user profile 240. Data manager 210 can create user profile 240 using the number of key value pairs 218 to create user details 242 in response to user profile 240 with user details 242 matching the number of key value pairs 218 being absent in profile database 236.

In this illustrative example, increased security for confidential information 221 can be achieved in the manner in which data is stored in profile database 236. For example, the number of keys 226 in the number of key value pairs 218 are used. With this example, the number of values 222 in the number of key value pairs 218 are not stored with user details 242 for the user profile 240 in profile database 236.

In addition to managing user profiles in profile database 236, data manager 210 can also manage the retention of information in secure database 228. For example, data manager 210 can purge a number of key value pairs 218 from secure database 228 using policy 246. In this example, policy 246 is a set of one or more rules and can include data used to apply the rules. For example, policy 246 can specify at least one of what type of data can be stored, how long data can be stored, what data should be retained indefinitely, and other types of rules.

In one illustrative example, one or more solutions are present that overcome a problem with managing confidential information received in messages in which the confidential information may not be expected in the messages. With the use of data manager 210 in the different illustrative examples, incoming messages can be handled in a manner that meets various regulations and laws with respect to confidential information even when the confidential information is received unexpectedly in the incoming messages. The illustrative example provides a quarantine and processing system that can handle unstructured or free-form customer communications.

In the illustrative example, the messages can be parsed into key value pairs and a redacted key plaintext form of the message. The matching key value pairs of known customer details can be used to update a customer profile or generate a new customer profile. The key value pairs are stored in a secure database and the redacted message is stored in a plaintext database. Further, the illustrative example can update customer profile information when updated user details are received in messages for that customer.

Computer system 208 can be configured to perform at least one of the steps, operations, or actions described in the different illustrative examples using software, hardware, firmware or a combination thereof. As a result, computer system 208 operates as a special purpose computer system in which data manager 210 in computer system 208 enables processing messages in a more secure fashion as compared to current techniques. The different illustrative examples can process messages that may contain unexpected confidential information. In particular, data manager 210 transforms computer system 208 into a special purpose computer system as compared to currently available general computer systems that do not have data manager 210.

In the illustrative example, the use of data manager 210 in computer system 208 integrates processes into a practical application for processing messages that increases the performance of computer system 208 in which a performance increase occurs in the ability to provide desired security for confidential information. In other words, data manager 210 in computer system 208 is directed to a practical application of processes integrated into data manager 210 in computer system 208 that include parsing a message to identify key value pairs for confidential information in the message, creating redacted message in which values and the key value pairs are replaced with plaintext tags, storing the key value pairs and secure database, and storing the redacted message in a plaintext database.

The illustration of data environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

In some illustrative examples, the message processing can omit updating profile database 236. In yet other illustrative examples, one or more secure databases can be present in addition to the secure database 228. These additional secure databases can be used to store key value pairs for different organizations. In other words, each organization may have a separate secure database for storing key value pairs.

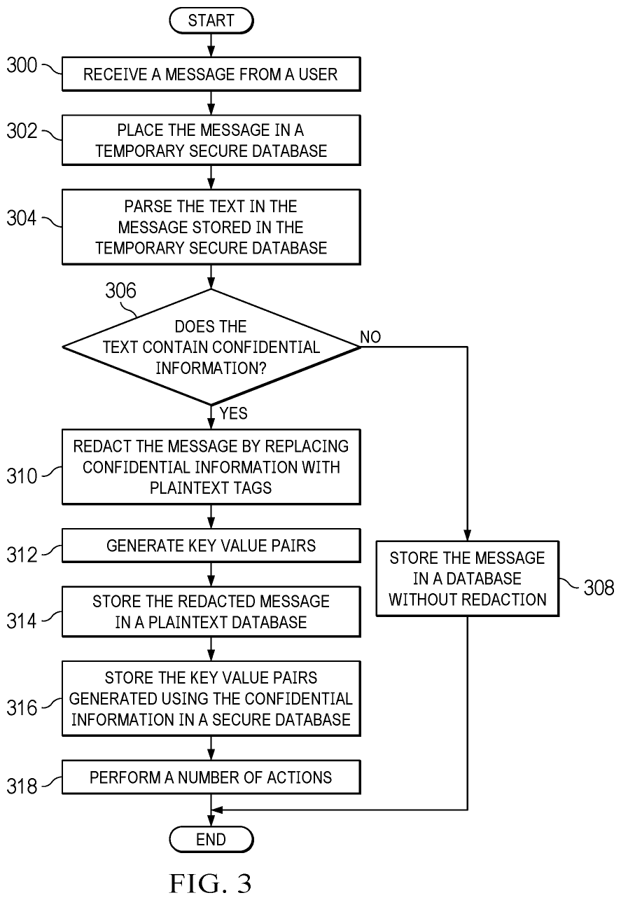

Turning next to FIG. 3, a flowchart of a process for splitting data in a message between a secure database and a plaintext database is depicted in accordance with an illustrative embodiment. The process in FIG. 3 can be implemented in hardware, software, or both. When implemented in software, the process can take the form of program instructions that is run by one of more processor units located in one or more hardware devices in one or more computer systems. For example, the process can be implemented in data manager 210 in computer system 208 in FIG. 2. The process can be used to process messages received by data management system 202.

The process begins by receiving a message from a user (step 300). In this example, the message can be an email message, a chat message, a web-based form, or text box in which data is entered by the user. For example, the message can be “Hello, I am locked out of my account. Please reset my password, here is my information SSN 234-45-4567, phone (123) 234-4444, 123 Main Street, MA.” This message contains confidential information that is unsolicited from the user.

The process places the message in a temporary secure database (step 302). The temporary secure database is a database that has security measures that meets rules and regulations for handling confidential information. This database holds messages that are to be examined to determine what, if any, confidential information is present in the messages.

The process parses the text in the message stored in the temporary secure database (step 304). The parsing is performed to identify confidential information that may be present in the message.

A determination is made as to whether the text contains confidential information (step 306). If the text does not contain confidential information, the process stores the message in a database without redaction (step 308). The process terminates thereafter.

With reference again to step 306, if the text contains confidential information, the process redacts the message by replacing confidential information with plaintext tags (step 310). The process generates key value pairs (step 312). In step 312, values in the key value pairs are the confidential information, and keys are the plaintext tags. The process stores the redacted message in a plain text database (step 314). The process stores the key value pairs generated using the confidential information in a secure database (step 316).

The process performs a number of actions (step 318). The process terminates thereafter. In step 318, the number of actions can include flagging the message as having excessive confidential information from the customer. In other words, confidential information, such as a mailing address or phone number, may have been included but was not requested. As another example, the number of actions can include notifying authorized users such as a data controller of potential liability. In yet another illustrative example, the number of actions can include contacting the user that supplied the excessive confidential information. Although step 318 is depicted as being performed after storing the key value pairs and the redacted message, this step can be performed in parallel during processing of the message in step 310, step 312, and step 316.

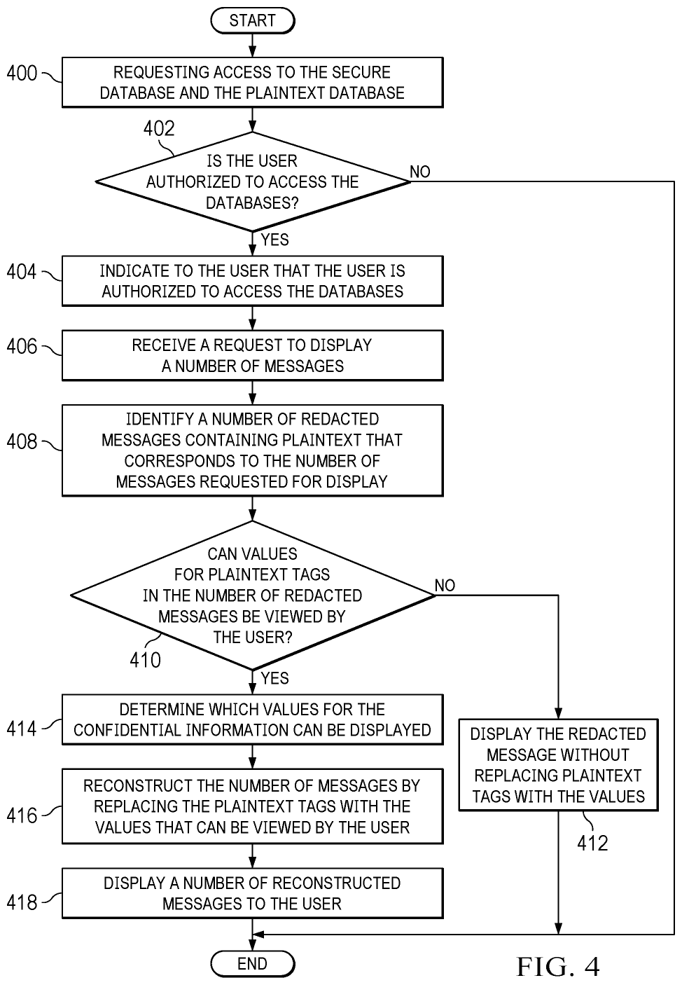

With reference now to FIG. 4, a flowchart of a process accessing messages is depicted in accordance with an illustrative embodiment. The process in FIG. 4 can be implemented in hardware, software, or both. When implemented in software, the process can take the form of program instructions that is run by one of more processor units located in one or more hardware devices in one or more computer systems. For example, the process can be implemented in data manager 210 in computer system 208 in FIG. 2. This process can be used to access messages that have been split into redacted messages stored in a plaintext database 230 and key value pairs for those messages stored in secure database 228.

The process begins by requesting access to the secure database and the plaintext database (step 400). In step 400, the user can request access by logging into a data management system such as data management system 202 in FIG. 2. The process determines whether the user is authorized to access the databases (step 402). If the user is not authorized access the databases, the process terminates.

Otherwise, the process indicates to the user that the user is authorized to access the databases (step 404). The process receives a request to display a number of messages (step 406). In this illustrative example, when the number of messages is more than one message, the number of messages can be a group of customer messages, a message chain with a customer, or some other grouping messages.

The process identifies a number of redacted messages containing plaintext that corresponds to the number of messages requested for display (step 408). The process determines whether values for plaintext tags in the number of redacted messages can be viewed by the user (step 410). If the user does not have authorization to view the values, the process displays the redacted message without replacing plaintext tags with the values (step 412) with the process terminating thereafter.

With reference again to step 410, if the user is authorized to view the values, the process determines which values for the confidential information can be displayed (step 414). In step 414, values for the confidential information that can be viewed by the user can depend on a number of different factors.

In this illustrative example, the values that can be viewed by the user may depend on the privilege or access level of the user. For example, a supervisor may have access to see address information, phone numbers, national IDs, credit card numbers, while a customer service representative may have access to see address information, phone numbers, credit card numbers, but not national IDs. As another example, the location of the computing device operated by the user can also be used to determine what values can be displayed. In yet another example, if the computing device is also verified, then more values may be displayed as compared to when the computing device is not verified.

The process reconstructs the number of messages by replacing the plaintext tags with the values that can be viewed by the user (step 416). The process displays a number of reconstructed messages to the user (step 418). The process terminates thereafter.

Thus, the number of messages displayed can be the original messages without plaintext tags in which all the confidential information can be viewed, a partial reconstruction of the number of messages in which portions of the confidential information can be viewed while other portions of the number of messages have plaintext tags, or in fully redacted form without confidential information and only plaintext tags. Further, different messages in the number of messages may have different amounts of confidential information that can be viewed as compared to other messages.

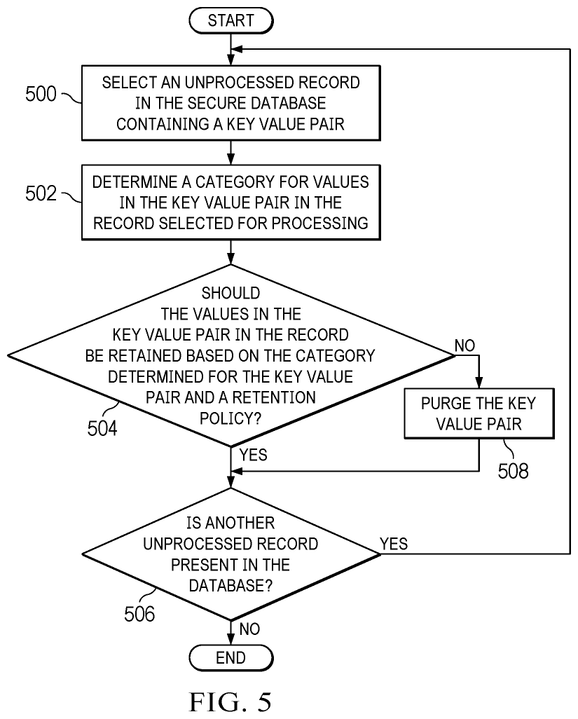

In FIG. 5, a flowchart of a process for purging data in a secure database is depicted in accordance with an illustrative embodiment. The process in FIG. 5 can be implemented in hardware, software, or both. When implemented in software, the process can take the form of program instructions that is run by one of more processor units located in one or more hardware devices in one or more computer systems. For example, the process can be implemented in data manager 210 in computer system 208 in FIG. 2. This process can be used to purge records containing key value pairs in secure database 228.

The process begins by selecting an unprocessed record in the secure database containing a key value pair (step 500). The process determines a category for values in the key value pair in the record selected for processing (step 502). In this illustrative example, categories or types of information can be, for example, name, date of birth, mailing address, street address, national ID, credit card number, bank account number, phone number, or other types of information.

The process determines whether the values in the key value pair in the record should be retained based on the category determined for the key value pair and a retention policy (step 504). In step 504, the retention policy is a set of rules that determines what key value pairs should be retained based on the categories of data. For example, one rule can be that all key value pairs should be removed except key value pairs for phone numbers for users with active contracts. As another example, key value pairs are removed for records that have a selected number of years of an inactivity. As another example, a key value pair for credit card information is purged regardless of the age of the key value pair.

If the key value pair in the record should be retained based on the category determined for the key value pairs, the process determines whether another unprocessed record is present in the database (step 506). If another unprocessed record is present, the process returns to step 500. Otherwise, the process terminates.

With reference again to step 504, if the key value pair in the record should not be retained based on the category determined for the key value pair, the process purges the key value pair (step 508). The process proceeds to step 506 as described above.

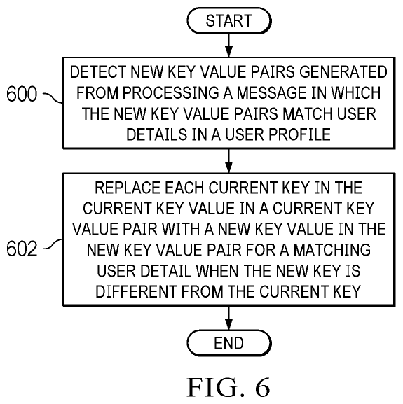

With reference now to FIG. 6, a flowchart of a process for updating a user profile is depicted in accordance with an illustrative embodiment. The process in FIG. 6 can be implemented in hardware, software, or both. When implemented in software, the process can take the form of program instructions that is run by one of more processor units located in one or more hardware devices in one or more computer systems. For example, the process can be implemented in data manager 210 in computer system 208 in FIG. 2. This process can be used to update user profiles 234 in profile database 236.

The process begins by detecting new key value pairs generated from processing a message in which the new key value pairs match user details in a user profile (step 600). For example, the processing of a message may generate a first key value pair for a phone number and a second key value pair for an email address. The message can include a name, a user identifier, a profile identifier, or other information that can be used to identify a profile of interest.

The process replaces each current key in a current key value pair with a new key in the new key value pair for a matching user detail when the new key is different from the current key (step 602). In step 602, some key value pairs may be replaced while others are not when only some of new key value pairs different from the current key value pairs in the profile for the user. In this illustrative example, the matching detail in the user profile is updated with the new key. The new value is not stored with the user profile in this example. The process terminates thereafter.

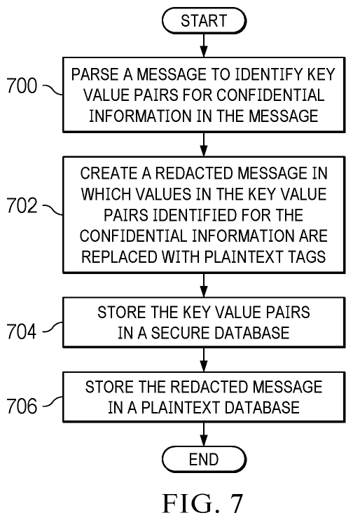

Tuning to FIG. 7, a flowchart of a process processing messages is depicted in accordance with an illustrative embodiment. The process in FIG. 7 can be implemented in hardware, software, or both. When implemented in software, the process can take the form of program instructions that is run by one of more processor units located in one or more hardware devices in one or more computer systems. For example, the process can be implemented in data manager 210 in computer system 208 in FIG. 2.

The process begins by parsing a message to identify key value pairs for confidential information in the message (step 700). The process creates a redacted message in which values in the key value pairs identified for the confidential information are replaced with plaintext tags (step 702).

The process stores the key value pairs in a secure database (step 704) and stores the redacted message in a plaintext database (step 706). The process terminates thereafter.

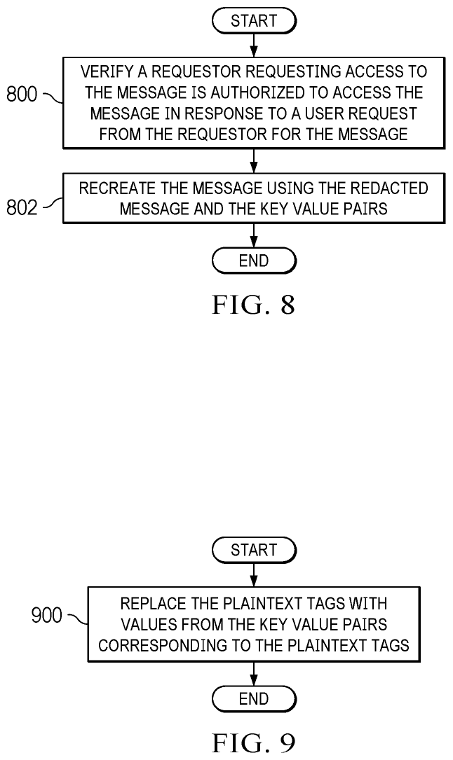

In FIG. 8, a flowchart of a process for accessing messages is depicted in accordance with an illustrative embodiment. The process in FIG. 8 is an example of additional steps that can be used with the steps in the process in FIG. 7.

The process verifies a requestor requesting access to the message is authorized to access the message in response to a user request from the requestor for the message (step 800). The process recreates the message using the redacted message and the key value pairs (step 802). The process terminates thereafter.

Turning to FIG. 9, a flowchart of a process for recreating a message is depicted in accordance with an illustrative embodiment. The process in FIG. 9 is an example of one implementation for step 802 in FIG. 8.

The process replaces the plaintext tags with values from the key value pairs corresponding to the plaintext tags (step 900). The process terminates thereafter.

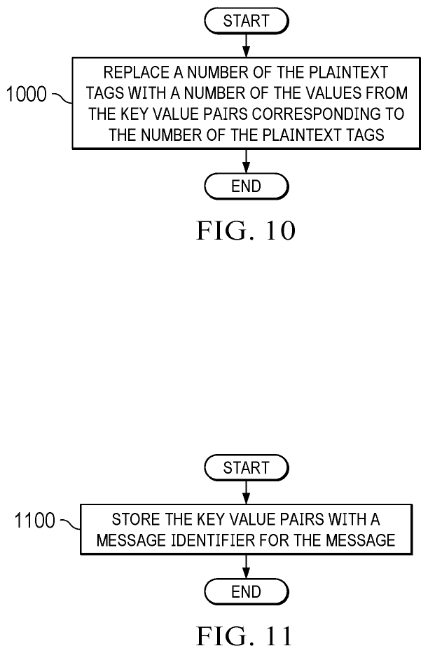

With reference next to FIG. 10, a flowchart of a process for recreating a message is depicted in accordance with an illustrative embodiment. The process in FIG. 10 is an example of one implementation for step 802 in FIG. 8.

The process replaces a number of the plaintext tags with a number of the values from the key value pairs corresponding to the number of the plaintext tags (step 1000). The process terminates thereafter. In step 1000, the number of the plaintext tags replaced with the number of the values can be selected by at least one of a user input selecting the number of the plaintext tags, user permissions, a geographic location of the user, or other criteria.

In FIG. 11, a flowchart of a process for storing key value pairs is depicted in accordance with an illustrative embodiment. The process in FIG. 11 is an example of one implementation for step 704 in FIG. 7.

The process stores the key value pairs with a message identifier for the message (step 1100). The process terminates thereafter. In this example, the confidential information are the values in the key value pairs. The plaintext tags replacing the confidential information in the message are the keys in the key value pairs. The message identifier identifies the message for which the key value pairs are generated.

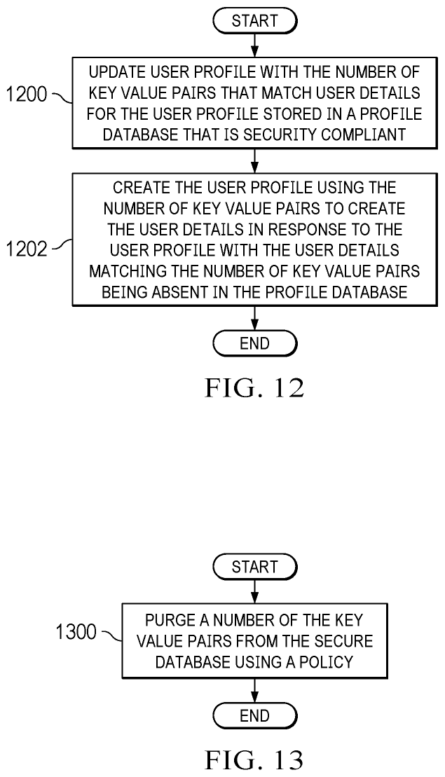

Turning to FIG. 12, a flowchart of a process for managing user profiles is depicted in accordance with an illustrative embodiment. The process in FIG. 12 is an example of additional steps that can be performed with the steps in the process in FIG. 7.

The process begins by updating a user profile with a number of key value pairs that match user details for the user profile stored in a profile database that is security compliant (step 1200). The process creates the user profile using the number of key value pairs to create the user details in response to the user profile with the user details matching the number of key value pairs being absent in the profile database (step 1202). The process terminates thereafter. In this example, the number of keys in the number of key value pairs are used in the profile, and the number of the values in the number of key value pairs are not stored with user details for the user profile.

With reference now to FIG. 13, a flowchart of a purging key value pairs is depicted in accordance with an illustrative embodiment. The process in FIG. 13 is an example of additional steps that can be performed with the steps in the process in FIG. 7.

The process purges a number of the key value pairs from the secure database using a policy (step 1300). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

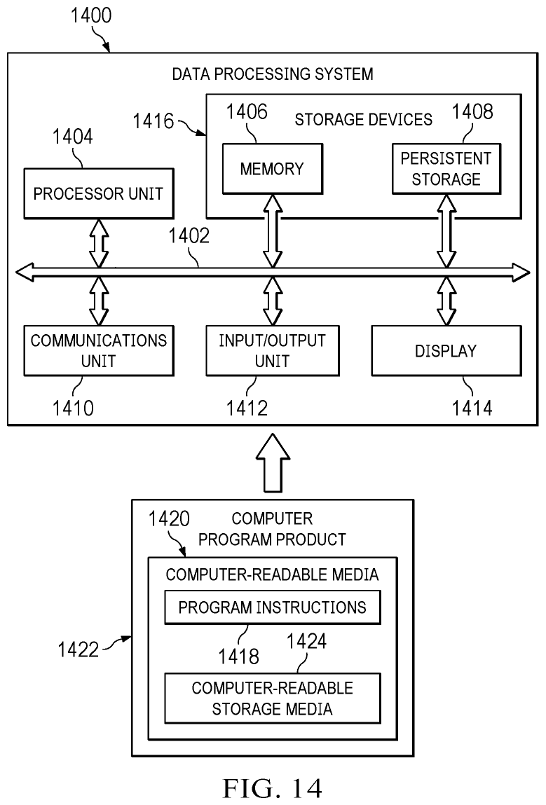

Turning now to FIG. 14, a block diagram of a data processing system is depicted in accordance with an illustrative embodiment. Data processing system 1400 can be used to implement computers and computing devices in computing environment 100 in FIG. 1. Data processing system 1400 can also be used to implement computer system 208 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can may be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, can be, for example, a random-access memory or any other suitable volatile or non-volatile storage device. Persistent storage 1408 may take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs can be located in storage devices 1416, which are in communication with processor unit 1404 through communications framework 1402. The processes of the different embodiments can be performed by processor unit 1404 using computer-implemented instructions, which may be located in a memory, such as memory 1406.

These instructions are referred to as program instructions, computer usable program instructions, or computer-readable program instructions that can be read and executed by a processor in processor unit 1404. The program instructions in the different embodiments can be embodied on different physical or computer-readable storage media, such as memory 1406 or persistent storage 1408.

Program instructions 1418 is located in a functional form on computer-readable media 1420 that is selectively removable and can be loaded onto or transferred to data processing system 1400 for execution by processor unit 1404. Program instructions 1418 and computer-readable media 1420 form computer program product 1422 in these illustrative examples. In the illustrative example, computer-readable media 1420 is computer-readable storage media 1424.

Computer-readable storage media 1424 is a physical or tangible storage device used to store program instructions 1418 rather than a medium that propagates or transmits program instructions 1418. Computer readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1418 can be transferred to data processing system 1400 using a computer-readable signal media. The computer-readable signal media are signals and can be, for example, a propagated data signal containing program instructions 1418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1420” can be singular or plural. For example, program instructions 1418 can be located in computer-readable media 1420 in the form of a single storage device or system. In another example, program instructions 1418 can be located in computer-readable media 1420 that is distributed in multiple data processing systems. In other words, some instructions in program instructions 1418 can be located in one data processing system while other instructions in program instructions 1418 can be located in one data processing system. For example, a portion of program instructions 1418 can be located in computer-readable media 1420 in a server computer while another portion of program instructions 1418 can be located in computer-readable media 1420 located in a set of client computers.

The different components illustrated for data processing system 1400 are not meant to provide architectural limitations to the manner in which different embodiments can be implemented. In some illustrative examples, one or more of the components may be incorporated in or otherwise form a portion of, another component. For example, memory 1406, or portions thereof, may be incorporated in processor unit 1404 in some illustrative examples. The different illustrative embodiments can be implemented in a data processing system including components in addition to or in place of those illustrated for data processing system 1400. Other components shown in FIG. 14 can be varied from the illustrative examples shown. The different embodiments can be implemented using any hardware device or system capable of running program instructions 1418.

Thus, the illustrative examples provide a method, apparatus, system, and computer program product for processing messages. In one illustrative example, a computer system parses a message to identify key value pairs for confidential information in the message. The computer system creates a redacted message from the message in which values in the key value pairs identified for the confidential information in the message are replaced with plaintext tags. The computer system stores the key value pairs in a secure database. The computer system stores the redacted message in a plaintext database.

With the use of the data manager in one or more the different illustrative examples, incoming messages can be handled in a manner that meets various regulations and laws with respect to confidential information even when the confidential information is received unexpectedly in incoming messages. The illustrative examples provide a quarantine and message processing system that can handle unstructured or free-form customer communications. In the illustrative example, the messages parsed into key value pairs and a redacted key plaintext form of the message. The key value pairs are stored in a secure database and the redacted message is stored in a plaintext database. The matching key value pairs of known customer details can be used to update a customer profile or generate a new customer profile. The key value pairs are stored in a secure database and the redacted message is stored in a plaintext database. Further, the illustrative example can update customer profile information when updated user details are received in messages for that customer.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for processing messages, the computer implemented method comprising:
parsing, by a computer system, a message to identify key value pairs for confidential information in the message;
creating, by the computer system, a redacted message in which values in the key value pairs identified for the confidential information are replaced with plaintext tags;
storing, by the computer system, the key value pairs in a secure database; and
storing, by the computer system, the redacted message in a plaintext database.

2. The computer implemented method of claim 1 further comprising:
verifying, by the computer system, a requestor requesting access to the message is authorized to access the message in response to a user request for the message; and
recreating, by the computer system, the message using the redacted message and the key value pairs.

3. The computer implemented method of claim 2, wherein recreating, by the computer system, the message using the redacted message and the key value pairs comprises:
replacing, by the computer system, the plaintext tags with values from the key value pairs corresponding to the plaintext tags.

4. The computer implemented method of claim 2, wherein recreating, by the computer system, the message using the redacted message and the key value pairs comprises:
replacing, by the computer system, a number of the plaintext tags with a number of the values from the key value pairs corresponding to the number of the plaintext tags.

5. The computer implemented method of claim 4, wherein the number of the plaintext tags replaced with the number of the values is selected by at least one of a user input selecting the number of the plaintext tags, user permissions, or a geographic location of a user.

6. The computer implemented method of claim 1, wherein storing, by the computer system, the key value pairs in the secure database comprises:
storing, by the computer system, the key value pairs with a message identifier for the message.

7. The computer implemented method of claim 1 further comprising:
updating, by the computer system, a user profile with a number of key value pairs that match user details for the user profile stored in a profile database that is security compliant; and
creating, by the computer system, the user profile using the number of key value pairs to create the user details in response to the user profile with the user details matching the number of key value pairs being absent in the profile database.

8. The computer implemented method of claim 7, wherein the number of keys in the number of key value pairs are used and the number of the values in the number of key value pairs are not stored with user details for the user profile.

9. The computer implemented method of claim 1 further comprising:
purging, by the computer system, a number of the key value pairs from the secure database using a policy.

10. A computer system comprising:
comprising a number of processor units, wherein the number of processor units executes program instructions to:
parse a message to identify key value pairs for confidential information in the message;
create a redacted message in which values in the key value pairs identified for the confidential information are replaced with plaintext tags;
store the key value pairs in a secure database; and
store the redacted message in a plaintext database.

11. The computer system of claim 10, wherein the number of processor units executes the program instructions to:
verify a requestor requesting access to the message is authorized to access the message in response to a user request from the requestor for the message; and
recreate the message using the redacted message and the key value pairs.

12. The computer system of claim 11, wherein in recreating the message using the redacted message and the key value pairs, the number of processor units executes the program instructions to:
replace the plaintext tags with values from the key value pairs corresponding to the plaintext tags.

13. The computer system of claim 11, wherein in recreating the message using the redacted message and the key value pairs, the number of processor units executes the program instructions to:
replace a number of the plaintext tags with a number of the values from the key value pairs corresponding to the number of the plaintext tags.

14. The computer system of claim 13, wherein the number of the plaintext tags replaced with the number of the values is selected by at least one of a user input selecting the number of the plaintext tags, user permissions, or a geographic location of a user.

15. The computer system of claim 10, wherein in storing the key value pairs in a secure database, the number of processor units executes the program instructions to:
store the key value pairs with a message identifier for the message.

16. The computer system of claim 10, wherein the number of processor units executes the program instructions to:
update a user profile with the number of key value pairs that match user details for the user profile stored in a profile database that is security compliant; and
create the user profile using the number of key value pairs to create the user details in response to the user profile with the user details matching the number of key value pairs being absent in the profile database.

17. The computer system of claim 16, wherein the number of keys in the number of key value pairs are used and the number of the values in the number of key value pairs are not stored with user details for the user profile.

18. The computer system of claim 10, wherein the number of processor units executes the program instructions to:
purge a number of the key value pairs from the secure database using a policy.

19. A computer program product for processing messages, the computer program product comprising a computer readable storage medium having program instructions embodied therewith, the program instructions executable by a computer system to cause the computer system to perform a method of:
parsing, by the computer system, a message to identify key value pairs for confidential information in the message;
creating, by the computer system, a redacted message in which values in the key value pairs identified for the confidential information are replaced with plaintext tags;
storing, by the computer system, the key value pairs in a secure database; and
storing, by the computer system, the redacted message in a plaintext database.

20. The computer program product of claim 19, wherein the method performed by the computer system further comprises:
verifying, by the computer system, a requestor requesting access to the message is authorized to access the message in response to a user request from the requestor for the message; and
recreating, by the computer system, the message using the redacted message and the key value pairs.
